(19) United States
(12) Patent Application Publication
(10) Pub. No.: US 2007/0296337 A1
(43) Pub. Date: Dec. 27, 2007

(54) Plasma Display Panel (PDP)

(76) Inventors: Tae-Woo Kim, Suwon-si (KR); Sang-Hoon Yim, Suwon-si (KR)

Correspondence Address: Robert E. Bushnell, Suite 300, 1522 K Street, N. W., Washington, DC, 20005-1202, US

(21) Appl. No.: 11/808,733

(22) Filed: Jun. 12, 2007

(30) Foreign Application Priority Data
Jun. 21, 2006 (KR) 10-2006-0055845

(51) Int. Cl. H01J 17/49

(52) U.S. Cl. 313/584; 313/582; 313/585

(57) ABSTRACT

A Plasma Display Panel (PDP) capable of reducing the number of address electrodes for each pixel, includes: a first substrate; a second substrate facing the first substrate; a plurality of discharge cells partitioned between the first and second substrates; address electrodes formed along a first direction between the first and second substrates; and display electrodes formed along a second direction crossing the first direction and separated from the address electrodes between the first and second substrates. At least two discharge cells among the plurality of discharge cells included in a respective pixel correspond to and are driven by the same address electrode, and the number of pixels that are arranged in a row along the second direction and enable a resolution of Rh×Rv is at least Rh/1.25, Rv being the number of pixels arranged along the first direction and Rh being the number of pixels arranged along the second direction.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on the 21 Jun. 2006 and there duly assigned Serial No. 10-2006-0055845.

### BACKGROUND OF THE INVENTION

1. Field of the Invention

The present invention relates to a Plasma Display Panel (PDP), and more particularly, the present invention relates to a PDP having a high resolution and an enhanced arrangement of pixels and electrodes to reduce power consumption.

2. Description of the Related Art

Generally, a Plasma Display Panel (PDP) is a display device which excites phosphors with vacuum ultraviolet rays radiated from plasma obtained through a gas discharge, and displays desired images with visible light, such as red (R), green (G), and blue (B) colors, generated by the excited phosphors.

The PDP enables extra-large size screens which are larger than 60 inches to be thinner than 10 cm. The PDP has an excellent capacity for reproducing colors and no distortion according to viewing angle since it is a self emissive display, like a Cathode Ray Tube (CRT). The PDP has advantages of greater productivity and lower cost due to a simpler method of manufacturing than a Liquid Crystal Display (LCD), and is spotlighted as the next generation industrial flat panel display and home TV display.

A three-electrode surface-discharge type PDP may be considered to be an example of a typical PDP. The three-electrode surface discharge PDP includes one substrate with two electrodes arranged on the same surface, and another substrate that is arranged a certain distance therefrom and includes address electrodes extending in a direction perpendicular to the substrates. A discharge gas is injected between the two substrates of the PDP.

In the PDP, whether or not the discharge occurs is determined by a discharge of scan electrodes and address electrodes that are connected to each line and independently controlled. A sustain discharge that displays an image occurs between sustain electrodes and scan electrodes that are located on the same surface.

FIG. 6 is a view of a stripe structure of barrier ribs of a PDP, and FIG. 7 is a view of a delta structure of barrier ribs of a PDP.

As shown in FIG. 6, in the PDP with the stripe structure of barrier ribs, discharge cells are respectively formed between sustain electrodes Xn to Xn+3 and scan electrodes Yn to Yn+3 that are disposed opposing each other, forming a discharge gap therebetween. Each pixel 61 of such a PDP includes three adjacent discharge cells 61R, 61G, and 61B of respectively red, green, and blue colors. Address electrodes 65 are formed to cross corresponding discharge cells among the discharge cells 61R, 61G, and 61B forming the pixels 61.

Therefore, regarding sixteen pixels 61 shown in the drawing, twelve address electrodes 65 (that is, Am, Am+1, . . . , Am+11) are required in total since four pixels are arranged in respective rows and each pixel requires three address electrodes. Furthermore, as the resolution of PDPs becomes higher, discharge cells are required to be arranged more densely. Accordingly, adjacent address electrodes 65 are required to be disposed closer together, and in such a case, a capacitance C between the adjacent address electrodes increases, thereby resulting in an increase of energy consumption (which is calculated as CV2f) of the PDP.

In addition, as shown in FIG. 7, in the PDP with the delta-shaped rib structure, discharge cells form separate spaces partitioned by barrier ribs. Each pixel 71 of such a PDP includes three adjacent discharge cells 71R, 71G, and 71B of respectively red, green, and blue colors that are arranged in a triangular pattern. Address electrodes 75 are formed to cross corresponding discharge cells among the discharge cells 71R, 71G, and 71B forming the pixels 71.

In this case also, regarding sixteen pixels 71 shown in the drawing, twelve address electrodes 75 (that is, Am, Am+1, . . . , Am+11) are required in total since four pixels are arranged in respective rows and each pixel requires three address electrodes. In this case also, discharge cells are required to be arranged more densely as the resolution of PDPs becomes higher. Consequently, adjacent address electrodes 75 are required to be disposed closer together, and in such a case, a capacitance C between the adjacent address electrodes increases, thereby resulting in an increase of energy consumption of the PDP.

### SUMMARY OF THE INVENTION

The embodiments of the present invention provide a Plasma Display Panel (PDP) that is capable of reducing the number of address electrodes in each pixel, thereby minimizing an increase of power consumption for a PDP of higher resolution as well as reducing the manufacturing cost of the PDP.

According to one aspect of the present invention, a plasma display panel is provided including: a first substrate; a second substrate facing the first substrate; a plurality of discharge cells partitioned between the first substrate and the second substrate; address electrodes arranged along a first direction between the first substrate and the second substrate; and display electrodes arranged along a second direction crossing the first direction and separated from the address electrodes between the first substrate and the second substrate; at least two discharge cells among a plurality of discharge cells included in a respective pixel correspond to and are driven by a same address electrode; and the number of pixels arranged in a row along the second direction and enabling a resolution of Rh×Rv is at least Rh/1.25, Rv being the number of pixels arranged along the first direction and Rh being the number of pixels arranged along the second direction.

Each pixel preferably includes three discharge cells, and centers of the three discharge cells are arranged in a triangular pattern.

The triangular pattern is preferably an isosceles triangle having two sides of equal length, and a third side arranged in parallel to the first direction.

Each pixel preferably has two address electrodes. The number of address electrodes arranged along the second direction is preferably at least 2×Rh/1.25.

The display electrodes preferably include pairs of sustain and scan electrodes corresponding to respective discharge cells, and wherein there are 3/2 scan electrodes per pixel. The number of scan electrodes arranged along the first direction is preferably Rv×3/2, and the number of address electrodes arranged along the second direction is preferably at least 2×Rh/1.25. Each of the sustain electrodes and scan electrodes preferably include a bus electrode extending along the second direction, and a transparent electrode wider than the bus electrode and extending along a direction of the bus electrode.

The resolution Rh×Rv is preferably 1920×1080. The resolution Rh×Rv is preferably alternatively 1366×768.

Each of the discharge cells preferably has a hexagonal plan shape. Each of the discharge cells preferably alternatively has a rectangular plan shape.

An extended line of a boundary of a pair of discharge cells adjacent to each other along the first direction preferably passes through centers of discharge cells adjacent to each other along the second direction.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) according to a first embodiment of the present invention.

FIG. 2 is a partial plan view of an arrangement of pixels and electrodes of a PDP according to the first embodiment of the present invention.

FIG. 3 is a schematic diagram for explaining the capacity of a discharge cell to display space-frequency in a PDP according to the first embodiment.

FIG. 4A and FIG. 4B are schematic diagrams for comparing space frequency according to an arrangement of pixels of the first embodiment of the present invention with that of a conventional PDP of a striped structure.

FIG. 5 is a partial plan view of an arrangement of pixels and electrodes of a PDP according to a second embodiment of the present invention.

FIG. 6 is a partial plan view of an arrangement of pixels and electrodes of a PDP.

FIG. 7 is a plan view of an arrangement of pixels and electrodes of another PDP.

### DETAILED DESCRIPTION OF THE INVENTION

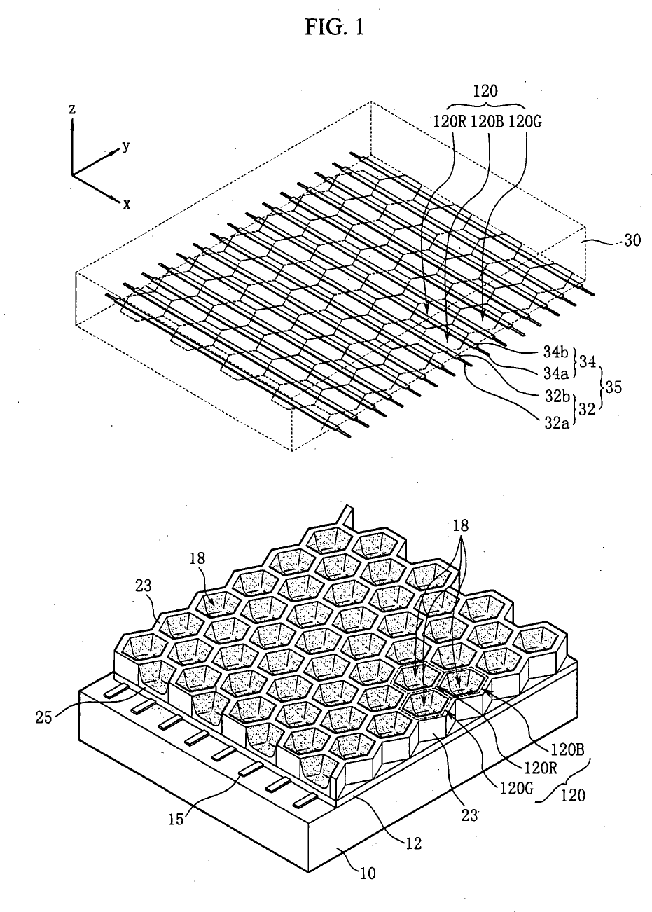

Referring to FIG. 1, a Plasma Display Panel (PDP) according to the present invention is a so-called delta arrangement cell PDP in which three subpixels of red, green, and blue colors in each pixel are arranged in a triangular pattern.

The PDP includes a first substrate (hereinafter referred to as a rear substrate) 10 and a second substrate (hereinafter referred to as a front substrate) 30 arranged substantially in parallel and joined together with a predetermined space therebetween.

Barrier ribs 23 having a predetermined height and pattern and partitioning pixels 120 are formed between the rear substrate 10 and the front substrate 30. Each pixel 120 includes three subpixels 120R, 120G, and 120B arranged in the above-mentioned triangular pattern.

The subpixels 120R, 120G, and 120B are also partitioned by the barrier ribs 23, and they respectively have corresponding discharge cells 18.

According to the present embodiment, plan shapes of the respective subpixels 120R, 120G, and 120B are formed in a generally hexagonal shape, and the barrier ribs 23 partitioning them are formed in a hexagonal or honeycomb pattern. Therefore, the discharge cells 18 of the respective subpixels 120R, 120G, and 120B are formed in a shape of a hexagonal prism that is open at its top.

The discharge cells 18 are provided with a discharge gas including xenon Xe, neon Ne, etc., for the plasma discharge. Phosphor layers 25 of red, green, and blue colors are respectively formed in the red, green, and blue subpixels 120R, 120G, and 120B. The phosphor layers 25 are formed on the bottoms of the discharge cells 18 and lateral sides of the barrier ribs 23.

Address electrodes 15 extend respectively along a first direction (y-axis direction in the drawings) on the rear substrate 10 and are arranged along a second direction (x-axis direction in the drawings). The address electrodes 15 are located below the discharge cells 18, that is, between the rear substrate and the barrier ribs. A dielectric layer 12 is formed on the front surface of the rear substrate 10 and covers the address electrodes 15. Therefore, the address electrodes 15 are located under a layer on which the barrier ribs 23 are formed.

Display electrodes 35 are arranged along the second direction on the front substrate 30. The display electrodes 35 include pairs of a sustain electrode 32 and a scan electrode 34, each pair of which forms a discharge gap and corresponds to respective discharge cells 18. The sustain electrodes 32 and the scan electrodes 34 are arranged alternately along the first direction.

The sustain electrode 32 and the scan electrode 34 respectively include bus electrode 32a and 34a and transparent electrodes 32b and 34b. The bus electrodes 32a and 34a extend along the second direction, and the transparent electrodes 32b and 34b are wider than the bus electrodes 32a and 34a and cover the bus electrodes 32a and 34a along the second direction.

The bus electrodes 32a and 34a can be made of a metallic material that has excellent electrical conductivity. The bus electrodes 32a and 34a may be formed with minimized widths as long as they have sufficient electrical conductivity, so as to minimize blocking of visible light generated in the discharge cells 18 during the operation of the PDP.

The transparent electrodes 32b and 34b are made of a transparent material, such as Indium Tin Oxide (ITO), and extend with the respective bus electrodes 32a and 34a along the second direction. Therefore, a pair of transparent electrodes 32b and 34b are arranged to face each other with a certain distance therebetween in each discharge cell 18.

In addition, on the front substrate 30, a dielectric layer (not shown) covering the sustain electrodes 32 and the scan electrodes 34 may be formed over the entire surface of the front substrate 30, and a protective layer (not shown) of MgO may be further formed thereon.

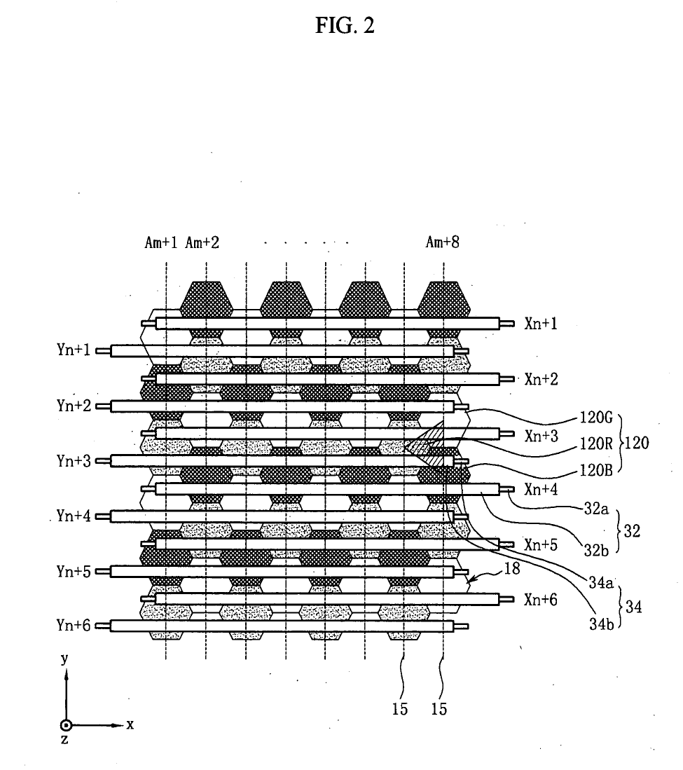

Referring to FIG. 2, according to the present embodiment, two address electrodes 15 correspond to each pixel 120. Each pixel 120 includes three subpixels 120R, 120G, and 120B that respectively produce visible light of red, green, and blue colors.

The centers of the subpixels 120R, 120G, and 120B that are included in the pixel 120 are arranged in a triangular pattern. More specifically, the centers of subpixels 120R, 120G, and 120B form an isosceles triangle that has two sides of equal length, and a third side arranged in parallel to the first direction (y-axis direction in the drawings). Two discharge cells 18 among the three discharge cells 18, that is, the subpixels 120R, 120G, and 120B included in the pixel 120, are adjacent to each other and arranged in parallel to the first direction. Since the subpixels 120R, 120G, and 120B are arranged in the above-described way, discharge spaces along the first direction are increased and are adequate for a discharge, and thus, the margin improves.

In addition, at least two subpixels among the subpixels 120R,120G, and 120B included in a pixel 120 correspond to the same address electrode 15 and are driven thereby. 3/2 of a scan electrode 34 corresponds to a pixel 120. As shown in FIG. 2, four pixels 120 are arranged in a first row along the second direction (x-axis direction in the drawings) and the number of address electrodes that correspond to the pixels 120 is eight (that is, Am+1 to Am+8). Thus, the number of address electrodes 15 per pixel 120 is two (8/4=2). In addition, four pixels 120 are arranged in the first row along the first direction and the number of scan electrodes 34 that correspond to the pixels 120 is six (that is, Yn+1 to Yn+6). Thus, the number of scan electrodes 34 per pixel 120 is 3/2 (6/4=3/2). In other words, the two address electrodes 15 and 3/2 of the scan electrode 34 determine whether or not a discharge of the three subpixels 120R, 120G, and 120B included in the pixel 120 occurs. More specifically, the two subpixels 120G and 120B, that include two discharge cells 18 adjacent to each other along the first direction, correspond to one address electrode 15, and the subpixel 120R that includes the third discharge cell 18 corresponds to another address electrode 15. The subpixels 120G and 120B of the two discharge cells 18 that correspond to the same address electrode 15 include phosphor layers 25 that produce visible light of different colors.

One scan electrode (Yn+3) corresponds to the two subpixels 120R and 120B of the discharge cells 18 that are adjacent to each other along the second direction (x-axis direction in the drawings), and another scan electrode (Yn+2) corresponds to the other subpixel 120G of the discharge cells 18. The two discharge cells and the one scan electrode (Yn+3) are arranged to include phosphor layers 25 producing visible light of different colors.

Sustain electrodes (Xn+3, Xn+4) are also arranged to correspond to a pixel 120 which includes the scan electrodes (Yn+3, Yn+2). The sustain electrodes (Xn+3, Xn+4) and the scan electrodes (Yn+3, Yn+2) are arranged to respectively face each other in the pixel 120.

The arrangement of the sustain electrodes 32 and the scan electrodes 34 that correspond to the pixel 120 can be set in the above-described way or not, according to a selection of pixels 120 that are arranged repetitively.

For example, the bus electrodes 32a and 34a may be arranged on the boundary of the respective discharge cells and extend to zigzag along the second direction, and the transparent electrodes 32b and 34b may protrude from the bus electrodes 32a and 34a into the centers of the respective discharge cells 18. As described above, when the scan electrodes 34 and the sustain electrodes 32 are arranged on the boundary of the respective discharge cells 18 and supply a common voltage to the pairs of discharge cells that are adjacent to each other along the boundary, ¾ of a scan electrode 34 corresponds to each pixel 120.

In the present embodiment, although the centers of the three subpixels 120R, 120G, and 120B included in a pixel 120 are arranged in a triangular pattern, the sustain electrodes 32 and the scan electrodes 34 are arranged in a linear pattern. Therefore, the sustain electrodes 32 and the scan electrodes 34 are arranged to pass the different two subpixels among the subpixels 120R, 102G, and 102B along the second direction on the plane. As a result, 3/2 of each of the sustain electrodes 32 and the scan electrodes 34 corresponds to each pixel 120 that includes three subpixels 120R, 120G, and 120B.

In other words, the scan electrode (Yn+3) on one side passes and supplies a common voltage to two subpixels 120R and 102B that are adjacent to each other along the second direction in a pixel 120, and the scan electrode (Yn+2) on the other side passes and supplies a voltage to one subpixel 120G in the same pixel 120. In addition, the scan electrode (Yn+2) passes and supplies a common voltage to the two subpixels 120G and 120B that are adjacent to each other along the second direction in another pixel 120.

The sustain electrodes 32 face the scan electrodes 34. The sustain electrode (Xn+4) faces the scan electrode (Yn+3), and corresponds to and supplies a voltage to one subpixel 120B in a pixel 120. In addition, the sustain electrode (Xn+4) passes the two subpixels 120R and 102G that are adjacent to each other along the second direction in another pixel 120, and supplies the above common voltage thereto. The other sustain electrode (Xn+3) corresponds to and supplies a common voltage to the two subpixels 120R and 120B in a pixel 120. In addition, the sustain electrode (Xn+3) faces the sustain electrode (Yn+3) and the other sustain electrode (Yn+2) on either side of the first direction. Therefore, the scan electrodes 34 and the sustain electrodes 32 are arranged alternately along the first direction and respectively control the operations of pairs of discharge cells 18.

Two address electrodes 15 and 3/2 of a scan electrode 34 correspond to each pixel 120. Therefore, considering four pixels 120 along the first direction and four pixels along the second direction, the average number of scan electrodes 34 passing the pixels 120 is six and that of the address electrodes 15 is eight.

In the present embodiment wherein two address electrodes 15 and 3/2 of a scan electrode 34 correspond to each pixel 120, the number of address electrodes 15 and scan electrodes 34 per pixel 120 satisfies the following ratio, namely:the number of address electrodes:the number of scan electrodes=4:3

In the embodiment of FIG. 2, four columns of pixels 120 are arranged along the second direction and four rows of pixels 120 are arranged along the first direction, and thus, a total of sixteen pixels 120 are arranged. In this case, since two address electrodes 15 correspond to each column of pixels 120, a total of eight address electrodes (that is, Am+1 to Am+8) 15 correspond to a total of sixteen pixels 120. In addition, since 3/2 scan electrodes 34 correspond to each row of pixels 120, a total of six scan electrodes (that is, Yn+1 to Yn+6) 34 correspond to the total of sixteen pixels 120. The number of sustain electrodes (that is, Xn+1 to Xn+6) per pixel 120 is the same as that of scan electrodes 34, and thus, a total of six sustain electrodes correspond to the total of sixteen pixels 120.

In this arrangement of pixels, two adjacent subpixels 120G and 120B corresponding to the same address electrode 15 include phosphor layers of different colors. In addition, all of the subpixels 120R, 120G, and 120B having phosphor layers of different colors may correspond to one address electrode 15.

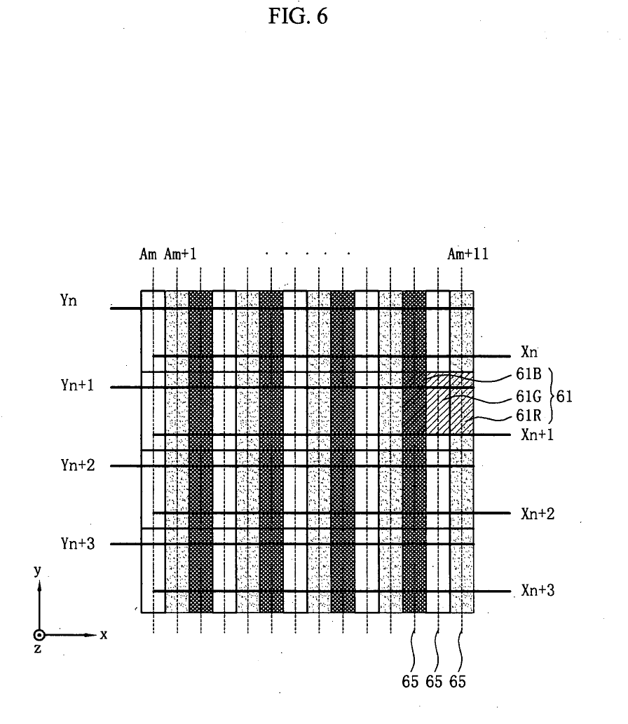

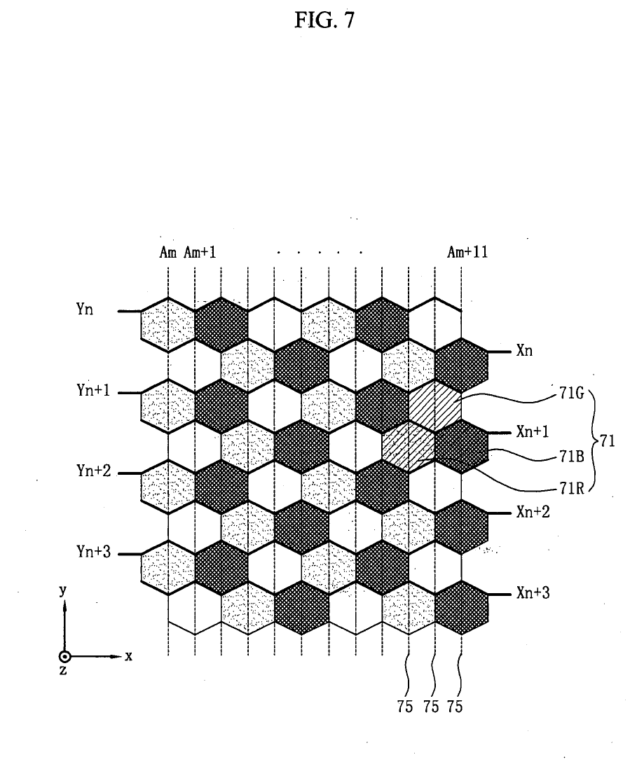

While the PDP of in FIG. 6 and FIG. 7 needs a total of twelve address electrodes, the PDP according to the present embodiment needs a total of eight address electrodes 15 per a total of sixteen pixels 120. Therefore, in the present embodiment, the number of address electrodes decreases as compared to the PDP of in FIG. 6 and FIG. 7 while the number of pixels remains the same. In other words, in the PDP according to the first embodiment of the present invention, the number of address electrodes 15 decreases by ⅓ of that of the PDP of in FIG. 6 and FIG. 7, and thus, the terminals of the address electrodes can easily be designed.

Therefore, the power consumption at the address electrodes 15 also decreases by ⅓ of that of the PDP of in FIG. 6 and FIG. 7. In addition, a peak power of an addressing device, for example, a Tape Carrier Package (TCP), that controls address electrodes 15 decreases by ⅓ of that of the PDP of in FIG. 6 and FIG. 7.

When compared to the fact that a total of four scan electrodes are needed in the PDP of in FIG. 6 and FIG. 7, a total of six scan electrodes 34 are needed in the present embodiment. Therefore, in the present embodiment, the number of scan electrodes increases compared to the PDP of in FIG. 6 and FIG. 7 while the number of pixels remains the same. Despite an increase of the number of scanning devices, a total cost of the circuit that operates the PDP can be decreased since scanning devices are cheaper than addressing devices.

In the present embodiment, each of the discharge cells 18 that form the respective subpixels 120R, 120G, and 120B is arranged in a hexagonal plan shape. Therefore, the discharge cells 18 include boundaries of sides in six respective directions. An extended line of the boundary of a pair of discharge cells 18 adjacent to each other along the first direction (y-axis direction in the drawings) is formed to pass through centers of discharge cells 18 adjacent to each other along the second direction (x-axis direction in the drawings) that crosses the address electrodes 15.

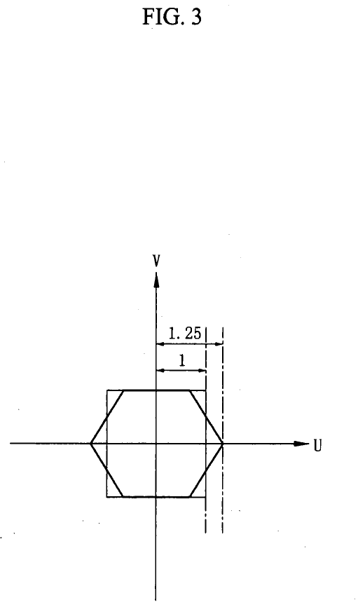

Referring to FIG. 3, when the subpixels are arranged in a way described in the present embodiment, that is, the centers of discharge cells form an isosceles triangle that has two sides of equal length, and the third side of the isosceles triangle is arranged in parallel to a direction of the extension of the address electrodes 15, a capacity for displaying space frequency in a horizontal direction, that is, the second direction (x-axis direction in the drawings), becomes 1.25 times higher. In other words, if it is assumed that the capacity for displaying space frequency in horizontal direction is 1 when subpixels are arranged in a conventional striped pattern, the capacity of discharge cells that are arranged in a delta pattern according to the present invention is 1.25. The space frequency is a characteristic frequency of a two-dimensional data image like that of a one-dimensional data image, that is, a numerical value that shows how often signals of the same frequency enter a certain space. In other words, the higher the space frequency is, the higher the resolution of images is, and the lower the space frequency is, the lower the resolution of images is. Therefore, in the present embodiment, the capacity for displaying space frequency is 1.25 in a horizontal direction, meaning that the capacity in a horizontal direction can be improved. The difference between the capacities for displaying space frequency will be described in more detail with regard to another drawing.

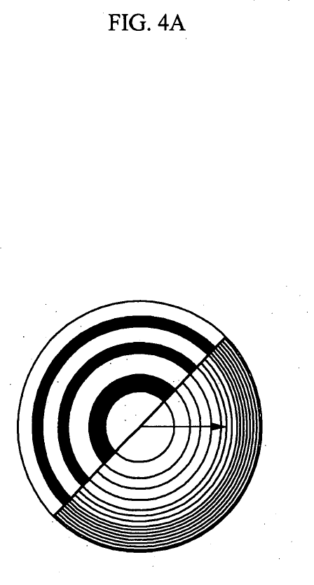

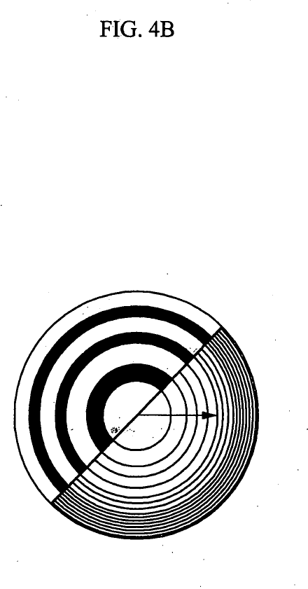

Referring to FIG. 4A, in the first embodiment of the present invention, the first to sixth circles along an arrow can be displayed. Referring to FIG. 4B, however, only the first to fifth circles along an arrow are recognizable. It is understood that in the arrangements of pixels according to the first embodiment of the present invention, the capacity for displaying space frequency is greater than that of a conventional PDP in a striped pattern.

In a PDP of a striped pattern the number of pixels per row along the second direction (that is, horizontal direction) is Rh in order to enable a resolution of Rh×Rv. However, in a PDP of a delta pattern according to the embodiment of the present invention, the number of pixels per row along the second direction can be smaller than Rh in order to enable a resolution of Rh×Rv. (Rv is the number of pixels that are arranged along the first direction, and Rh is the number of pixels that are arranged along the second direction.) Specifically, in the present embodiment, as the discharge cell's capacity for displaying space frequency in a horizontal direction is 1.25 times that of a PDP in a striped pattern, the number of pixels arranged along the second direction can be Rh/1.25 in order to enable a resolution of Rh×Rv. As described above, as 1.25 is the maximum value of discharge cell's capacity for displaying space frequency in a horizontal direction, the number of pixels substantially arranged along the second direction can be set to be equal to or greater than Rh/1.25. In addition, the number of pixels arranged per row along the second direction can be set to be smaller than Rh and equal to or greater than Rh/1.25. That is, the number of pixels arranged per row along the second direction is at least Rh/1.25.

Since the number of pixels arranged per row along the second direction is at least Rh/1.25, the number of address electrodes arranged along the second direction can be further decreased. In the present embodiment, two address electrode correspond to each pixel and thus, the minimum number of address electrodes arranged along the second direction can be 2×Rh/1.25. In addition, in the present embodiment, 3/2 of a scan electrode correspond to each pixel, and thus, the number of scan electrodes that are arranged along the first direction in order to enable a resolution of Rh×Rv is Rv×3/2. The above-described number of pixels is the number of pixels comprising discharge cells, and cells that can be formed by dummy barrier ribs in a dummy area are excluded.

For example, in a PDP having a resolution of 1920×1080 (FHD resolution) the number of pixels arranged per row in a horizontal direction can be at least 1920/1.25=1536, the number of address electrodes arranged in a horizontal direction can be at least 2×1920/1.25=3072, and the number of scan electrodes arranged in a horizontal direction can be 1080×3/2=1620.

In addition, in a PDP having a resolution of 1366×768 (XGA resolution) the number of pixels arranged per row in a horizontal direction can be at least 1366/1.25=1093, the number of address electrodes arranged in a horizontal direction can be at least 2×1366/1.25=2186, and the number of scan electrodes arranged in a horizontal direction can be 768×3/2=1152. As above, although the number of scan electrodes increases, the effect of decreases in the number of address electrodes is greater so that the power consumption at the address electrodes is reduced and the cost of manufacturing goes down with the decreased number of addressing circuits.

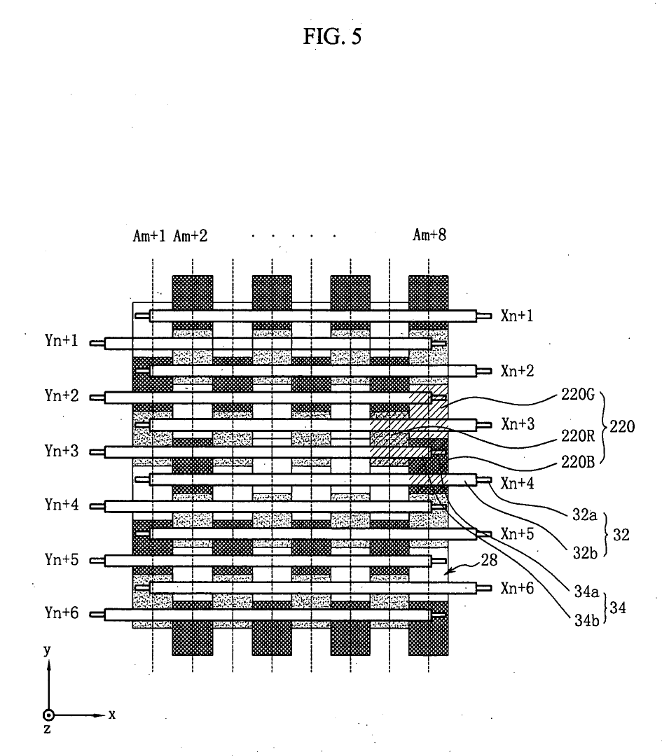

Referring to FIG. 5, when compared to the first embodiment, the second embodiment of the present invention is similar to the first embodiment in elements, functions, and effects, but is different therefrom in a plan shape of subpixels 220R, 220G, and 220B that are included in a pixel 220. That is, a discharge cell 28 that forms each of the subpixels 220R, 220G, and 220B is formed in a rectangular shape. Thus, it can be seen that the plan shape of discharge cells can vary. In the present embodiment as well, an extended line of the boundary of a pair of discharge cells 28 adjacent to each other along the first direction (y-axis direction in the drawings) is formed to pass through centers of discharge cells 28 adjacent to each other along the second direction (x-axis direction in the drawings).

Although certain exemplary embodiments of the present invention have been shown and described, the present invention is not limited to the described embodiments, but maybe modified in various ways without departing from the scope of the present invention set forth in the detailed description, the accompanying drawings, and the appended claims.

What is claimed is:

1. A Plasma Display Panel (PDP) comprising:
a first substrate;
a second substrate facing the first substrate;
a plurality of discharge cells partitioned between the first substrate and the second substrate;
address electrodes arranged along a first direction between the first substrate and the second substrate; and
display electrodes arranged along a second direction crossing the first direction and separated from the address electrodes between the first substrate and the second substrate;
wherein at least two discharge cells among a plurality of discharge cells included in a respective pixel correspond to and are driven by a same address electrode; and
wherein the number of pixels arranged in a row along the second direction and enabling a resolution of Rh×Rv is at least Rh/1.25, Rv being the number of pixels arranged along the first direction and Rh being the number of pixels arranged along the second direction.

2. The PDP of claim 1, wherein each pixel comprises three discharge cells, and wherein centers of the three discharge cells are arranged in a triangular pattern.

3. The PDP of claim 2, wherein the triangular pattern is an isosceles triangle having two sides of equal length, and a third side arranged in parallel to the first direction.

4. The PDP of claim 1, wherein each pixel has two address electrodes.

5. The PDP of claim 1, wherein the number of address electrodes arranged along the second direction is at least 2×Rh/1.25.

6. The PDP of claim 1, wherein the display electrodes include pairs of sustain and scan electrodes corresponding to respective discharge cells, and wherein there are 3/2 scan electrodes per pixel.

7. The PDP of claim 6, wherein the number of scan electrodes arranged along the first direction is Rv×3/2, and the number of address electrodes arranged along the second direction is at least 2×Rh/1.25.

8. The PDP of claim 6, wherein each of the sustain electrodes and scan electrodes include a bus electrode extending along the second direction, and a transparent electrode wider than the bus electrode and extending along a direction of the bus electrode.

9. The PDP of claim 1, wherein the resolution Rh×Rv is 1920×1080.

10. The PDP of claim 1, wherein the resolution Rh×Rv is 1366×768.

11. The PDP of claim 1, wherein each of the discharge cells has a hexagonal plan shape.

12. The PDP of claim 1, wherein each of the discharge cells has a rectangular plan shape.

13. The PDP of claim 1, wherein an extended line of a boundary of a pair of discharge cells adjacent to each other along the first direction passes through centers of discharge cells adjacent to each other along the second direction.
